(19) United States
(12) Patent Application Publication
(10) Pub. No.: US 2009/0094055 A1
(43) Pub. Date: Apr. 9, 2009

(54) SYSTEM AND METHOD FOR PROVIDING PRICE ESTIMATES FOR MEDICAL PROCEDURES

(75) Inventors: Gaston H. GAGE, JR., Charlotte, NC (US); Stephen M. Gage, Charlotte, NC (US)

Correspondence Address: TILLMAN WRIGHT, PLLC, PO BOX 473909, CHARLOTTE, NC, 28247, US

(73) Assignee: EMPOWERED BENEFITS, LLC, Charlotte, NC (US)

(21) Appl. No.: 12/061,629

(22) Filed: Apr. 2, 2008

Related U.S. Application Data
(60) Provisional application No. 60/909,695, filed on Apr. 2, 2007.

(51) Int. Cl. G06F 17/00; G06Q 50/00

(52) U.S. Cl. 705/2; 705/400

(57) ABSTRACT

A system for providing price information for medical procedures. The system includes a user interface configured to receive patient information corresponding to a patient, an eligibility engine configured to send a health care benefit inquiry and receive a health care benefit response from an insurer or a clearinghouse for a plurality of insurers based on received patient information, and a pricing engine configured to request and receive price data for a particular medical procedure based on the received patient information. The user interface is further configured to present pricing information to a user based on the received health care benefit response and the received price data.

### CROSS-REFERENCE TO RELATED APPLICATION

The present application is a non-provisional patent application of, and claims the benefit under 35 U.S.C. § 119(e) to, U.S. Provisional Patent Application No. 60/909,695, filed Apr. 2, 2007, which is expressly incorporated herein by reference.

### COPYRIGHT STATEMENT

All of the material in this patent document is subject to copyright protection under the copyright laws of the United States and of other countries. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE PRESENT INVENTION

1. Field of the Present Invention

The present invention generally relates to a system for providing medical price information to patients and more particularly to a system for providing medical price estimates to particular patients for particular medical procedures.

2. Background

The consumer-driven healthcare movement is creating a new type of healthcare consumer: one who is proactive in learning and understanding the prices of healthcare procedures and services. This behavior change has begun to create a dilemma for hospitals, as they must now determine how best to answer patient price inquiries. Exacerbating this dilemma, the American Hospital Association® has promoted a hospital price transparency protocol, whereby all patients have access to hospital pricing in layman's terms.

A process that provides patients with the estimated prices of healthcare procedures would be advantageous to both medical facilities and patients.

### SUMMARY OF THE PRESENT INVENTION

The present invention includes many aspects and features. Moreover, while many aspects and features relate to, and are described in, the context of a system for providing medical price estimates to patients for particular medical procedures, the present invention is not limited to use only in providing price estimates for medical procedures, as will become apparent from the following summaries and detailed descriptions of aspects, features, and one or more embodiments of the present invention.

Accordingly, one aspect of the present invention relates to a system for providing price information for medical procedures. An exemplary such system includes a user interface configured to receive patient information corresponding to a patient; an eligibility engine configured to send a health care benefit inquiry and receive a health care benefit response from an insurer or a clearinghouse for a plurality of insurers based on received patient information; and a pricing engine configured to request and receive price data for a particular medical procedure based on the received patient information. The user interface is further configured to present pricing information to a user based on the received health care benefit response and the received price data.

Furthermore, in this aspect of the invention, the eligibility engine, by sending the health care benefit inquiry and receiving the health care benefit response, may determine whether and to what extent the patient is eligible for insurance benefits. Still yet in this aspect, the pricing engine may communicate with an historical pricing database to receive the price data for the particular medical procedure.

In variations of this aspect, the patient information may include information pertaining to the particular medical procedure; the patient information may include insurance information for the patient; the user interface may include an authorization module configured to determine security clearance of a user thereof; the user interface may be accessible by the user via a network; the eligibility engine may send health care benefit inquiries using an ANSI X12N 270 electronic format; the eligibility engine may receive health care benefit responses using an ANSI X12N 271 electronic format; the health care benefit response may include coverage amounts for which the patient is eligible; the user interface may be further configured to receive information pertaining to a particular hospital or medical facility; the pricing information may include an estimate of a total cost of the particular medical procedure; and the pricing information may include an estimate of an amount that the patient is required to pay in connection with the particular medical procedure.

In accordance with a feature of this aspect of the invention, the health care benefit response may further include a deductible amount for the patient, and may further include a copayment amount for the patient.

Another aspect of the invention relates to a system for providing price information for medical procedures. An exemplary such system includes a user interface accessible to a user via a network and configured to receive patient information corresponding to a patient; an eligibility engine configured to send a health care benefit inquiry and receive a health care benefit response from an insurer or a clearinghouse for a plurality of insurers based on received patient information to determine whether and to what extent the patient is eligible for insurance benefits; and a pricing engine configured to communicate with an historical pricing database to request and receive price data for a particular medical procedure based on the received patient information. Furthermore, in this aspect of the invention, the user interface is further configured to present pricing information to the user based on the received health care benefit response and the received price data, and the pricing information includes an estimate of an amount that the patient is required to pay in connection with the particular medical procedure.

In variations of this aspect, the eligibility engine may send health care benefit inquiries using an ANSI X12N 270 electronic format; the eligibility engine may receive health care benefit responses using an ANSI X12N 271 electronic format; and the user interface may be configured to receive information pertaining to a particular hospital or medical facility.

Another aspect of the invention relates to a method of providing price information for medical procedures. An exemplary such method includes selecting a medical procedure whose price is to be estimated; sending a health care benefit inquiry via a first interface; receiving a health care benefit response via the first interface; requesting price data, from a database, for the selected medical procedure via a second interface; and receiving price data, from the database, for the requested medical procedure via the second interface.

In variations of this aspect, the method may further include calculating an estimated price for the medical procedure based on the received health care benefit response and the received price data.

In addition to the aforementioned aspects and features of the present invention, it should be noted that the present invention further encompasses the various possible combinations of such aspects and features. Moreover, further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a schematic representation of a price estimate system in accordance with a preferred embodiment of the present invention;

FIGS. 2A-2C are a flowchart representation of a price estimate process in accordance with one or more preferred embodiments of the present invention;

FIG. 3 is a portion of a screen view of an exemplary implementation of a login screen of the price estimate process;

FIG. 4 is a screen view of an exemplary implementation of a patient information screen of the user interface, presented to the user as part of the price estimate process;

FIG. 5A is a screen view of an exemplary implementation of a basic procedure search screen of the user interface, presented to the user as part of the price estimate process;

FIG. 5B is a screen view of an exemplary implementation of an expert procedure search screen of the user interface, presented to the user as part of the price estimate process;

FIG. 6 is a screen view of an exemplary implementation of a price estimate screen of the user interface, presented to the user as part of the price estimate process; and

FIG. 7 is a schematic representation of a price estimate system in accordance with another preferred embodiment of the present invention.

### DETAILED DESCRIPTION OF THE PREFERRED EMBODIMENTS

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Lastly, the invention illustratively disclosed herein suitably may be practiced in the absence of any element which is not specifically disclosed herein.

As used herein, the phrase “medical procedure” shall include medical services, as well as medical procedures. The phrase shall additionally be interpreted both conjunctively and disjunctively in the singular and plural. Thus, the phrase “medical procedure” may refer to one medical procedure, or it may refer to one medical procedure and one medical service, or it may refer to two medical procedures, or it may refer to two medical procedures and one medical service, or it may refer to two medical services.

Further, as used herein, the phrase “patient” shall include both patients and potential patients. The word patient shall additionally include, where appropriate, any person or entity acting on the patient's behalf.

Referring now to the drawings, in which like numerals represent like components throughout the several views, the preferred embodiments of the present invention are next described. The following description of the preferred embodiment(s) is merely exemplary in nature and is in no way intended to limit the invention, its application, or uses.

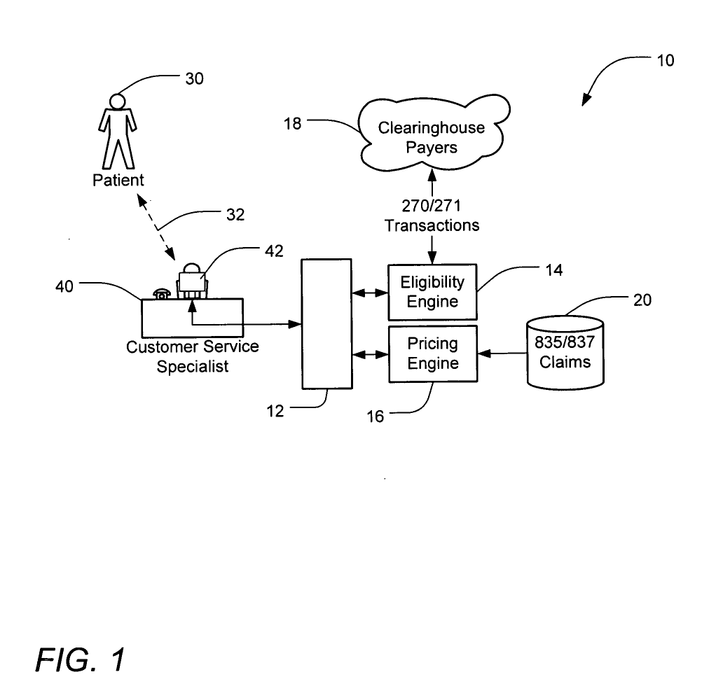

FIG. 1 is a schematic representation of a price estimate system 10 in accordance with a preferred embodiment of the present invention. The price estimate system 10 may be utilized to provide a patient 30 with an estimated price for a particular medical procedure. This medical procedure may be one that the patient 30 is considering or planning on having performed, or it may be one that the patient 30 is merely curious about the price of. Using a communication means 32, the patient 30 may communicate with a customer service representative 40 having access to the system 10. The patient, in his communication, may request a price estimate for a medical procedure and provide the customer service representative 40 with information needed to generate a price estimate.

In at least some embodiments, the customer service representative 40 is an employee of a hospital, clinic or other medical facility (each referred to hereinafter as a “facility”) at which or through which the patient 30 is considering having the procedure performed. However, in other embodiments, the customer service representative 40 may be employed by a third party, a consortium of facilities, or any of a variety of alternative arrangements.

The communication means 32 by which the patient 30 may communicate with the customer service representative 40 include fixed or mobile telephones and a public switched telephone network, email and other components of the Internet, and the like. Communication may likewise be carried out in person.

The system 10 itself generally includes one or more software applications implemented on any appropriate configuration of hardware, as will be appreciated by the Ordinary Artisan. The system 10 includes a system core 12, an eligibility engine 14, a pricing engine 16, and a user interface 42. The system core 12 manages most functionality and interfaces with the other elements to efficiently process requests. The eligibility engine 14 utilizes an interface to interact with a clearinghouse 18 to determine whether and to what extent the patient 30 is eligible for insurance benefits. This interface allows the electronic exchange of information using data organized according to government-approved insurance formats, conventionally referred to as “Health Care Benefit Inquiries” and “Health Care Benefit Responses.” Such formats will be described in greater detail below. The pricing engine 16 communicates through an interface with a historical pricing database 20 to obtain pricing information used to calculate the price estimate to be provided to the patient 30. The historical pricing database 20 is created using information derived from data organized according to government approved claim and remittance formats. Such formats will be described in greater detail below.

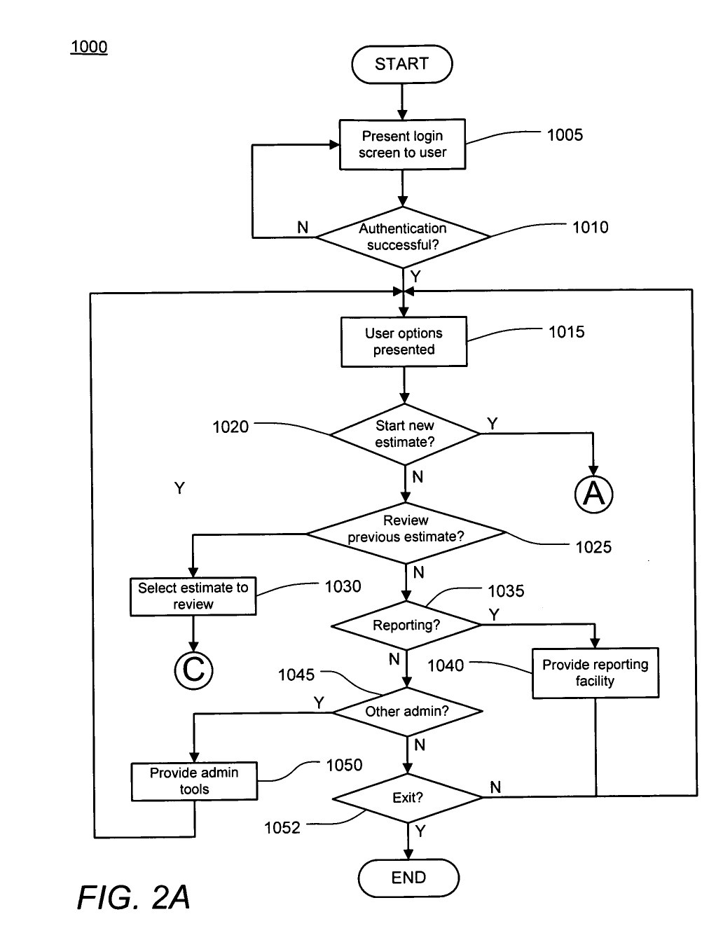

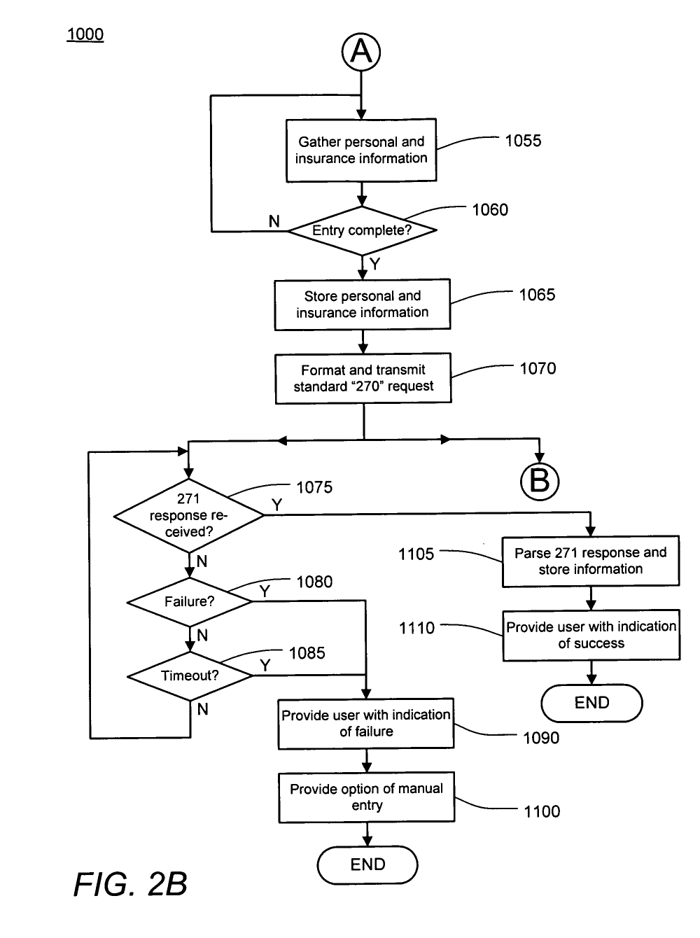

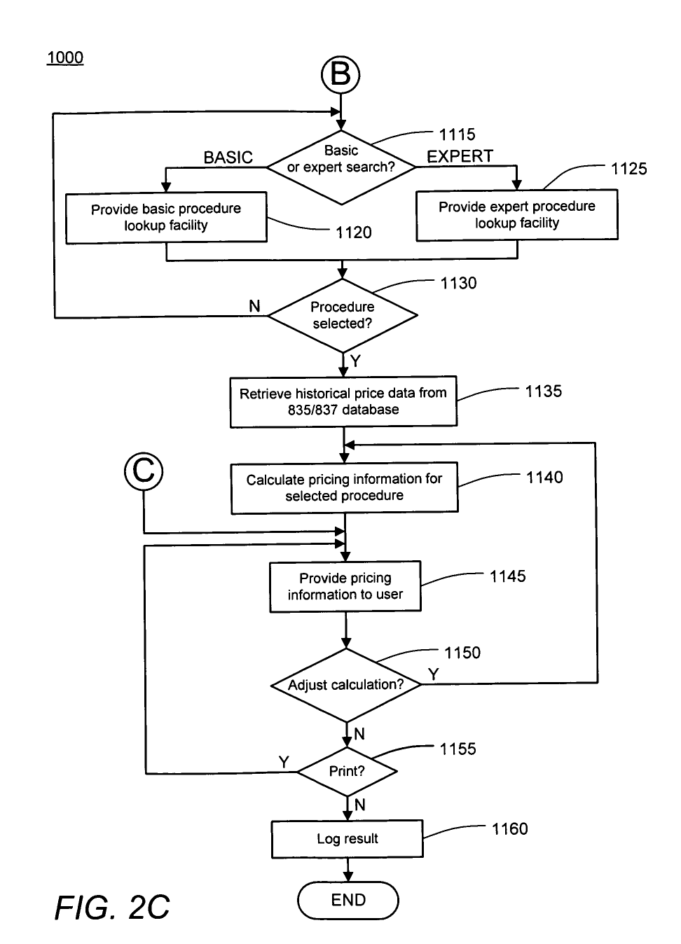

FIGS. 2A-2C are collectively a flowchart representation of a price estimate process 1000 in accordance with preferred embodiments of the present invention. More particularly, FIG. 2A is a flowchart representation of various steps of an authentication and main menu sub-process of the price estimate process 1000, FIG. 2B is a flowchart representation of various steps of an eligibility verification sub-process of the price estimate process 1000, and FIG. 2C is a flowchart representation of various steps of a calculation sub-process of the price estimate process 1000. In general, the price estimate process 1000 provides a user with an estimate of the price of a particular medical procedure. In at least one anticipated commercial embodiment, it is contemplated that medical facility personnel will use the price estimate process 1000 to provide a patient 30 with an estimate of the expenses that he or she will likely incur as a result of a particular medical procedure, e.g., an MRI of a particular body part. The price estimate preferably includes a plurality of components, including an estimate of the expected price to be paid by a patient's insurance carrier and an estimate of the expected price to be paid by the patient 30. As used herein, the term “insurance carrier” includes, but is not limited to, Medicare® and Medicaid. As is well known, Medicare and Medicaid are government-sponsored hospitalization and medical insurance programs for which the patient pays no fee, at least not directly; however, for purposes of this application, these programs will be considered to be included in the definition of insurance carriers.

The price estimate process 1000 includes a plurality of user inputs. Such user inputs could include, but are not limited to: user login information, personal and insurance information for the patient, and information specifying or indicating one or more particular medical procedures for which price information is requested. The process 1000 uses these inputs to determine whether the user is a valid user, whether the patient 30 is eligible for insurance coverage, and the price estimate for the patient's 30 particular procedure.

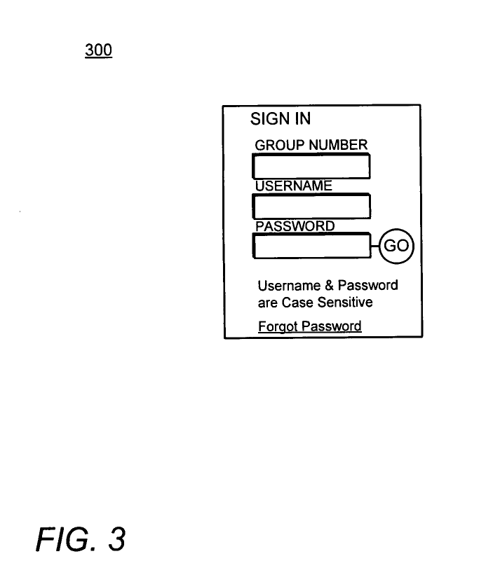

As shown in FIG. 2A, the price estimate process 1000 begins with step 1005, wherein the user interface 42 presents the user with a login screen 300, a portion of an exemplary implementation of which is shown in FIG. 3. The login screen 300 may have a plurality of requested inputs. In the exemplary screen, the requested inputs are an organization number, a user name, and a password. The organization number is unique to a particular facility, and the user name and password should be unique to a particular user. A user enters the requested information at the login screen, and at step 1010, a login application interfaces with a security/authentication module to determine whether a particular user is authorized to log in to the software applications and to determine the security clearance of the particular employee if the facility has chosen to set security levels.

As described previously, in the embodiment of FIG. 1, it is preferred that a user be a facility employee (such as a customer service representative 40) or other designated intermediary, rather than a consumer or patient 30. In this regard, it is contemplated that, for convenience of use by facility employees, the login screen 300 of the user interface 42, presented as part of the process 1000, may be accessible via a facility intranet or it may be part of a public website, but it will be appreciated that other configurations are likewise possible. Further, it will be appreciated that if the process 1000 is implemented within a particular facility, and access to various software systems in that facility is controlled by a separate login/authentication process, it may not be necessary to have a separate login screen 300 or steps 1005,1010 for the price estimate process 1000.

In at least some embodiments, in order to use the price estimate process 1000 and its associated software, a facility becomes a client of the software applications, which are provided according to a Software as a Service (“SaaS”) delivery model. In other embodiments, the software is provided in an application service provider (“ASP”) model. In still other embodiments, the software is installed directly on one or more servers or other computers of the facility. In still other embodiments, which may overlap with previously enumerated embodiments, the software is stored on a remote server.

A process administrator, who may be a facility employee or may be employed by a third party, such as the vendor supplying software components of the system 10, preferably controls the price estimate process 1000 and access thereto. When the facility initially becomes a client, the process administrator is provided with or otherwise develops a list of authorized employee names and passwords from which is developed a user authentication module (not illustrated). The process administrator may also be provided with or otherwise develop information such as employee roles and permission levels. This information may be used to create levels of security within the authentication module. The process administrator may also establish or provide an organization number for the facility, for a organization or unit within the facility, for a group of facilities or an organization spread across multiple facilities, or for any other appropriate unit or organization. The organization number may then be disseminated to employees of the facility and used by the employees when logging in to the system 10.

Returning to FIG. 2A, once a user has been authenticated and is logged in at steps 1005 and 1010, he or she will be presented with a plurality of process options at step 1015. In at least some embodiments, the user will have the choice of starting a new price estimate (represented by step 1020), reviewing an existing price estimate (represented by step 1025), reporting (represented by step 1035), or carrying out other administrative tasks (represented by step 1045). Although listed as separate steps, it will be appreciated that the user interface 42 preferably offers all of these options concurrently to the user as shown at step 1015, and further that the user interface 42 preferably also concurrently allows the user to exit entirely, as shown at step 1052.

If at step 1020 the user chooses to start a new price estimate, the process 1000 continues to an eligibility verification sub-process as shown in FIG. 2B. If at step 1025 the user chooses to review a price estimate that has been previously generated and stored, the process 1000 provides the user with access to the existing estimate at step 1030 and continues to a portion of the calculation sub-process as shown in FIG. 2C. Notably, access to existing price estimates is preferably limited to customer service representatives having an appropriate level of access authority, such level of authority being higher or otherwise different than a general access authority, or in at least one embodiment, to individual patients 30 wishing to view price estimates they requested previously. In at least one embodiment, a patient 30 or other user may be given a level of authority specific to a certain class or type of procedure. If at step 1035 the user chooses to generate reports, the system 10 provides the user with a facility at step 1040 for generating any of various reports, which may for example include, but are not limited to, a detailed listing of all price estimates generated during a user-specified time period (e.g. previous quarter, previous month, previous week, or a range of weeks or other date range), a listing of the procedures for which the most price estimates were requested or given, or the like. If at step 1045 the user chooses to access available administrative tasks, the system 10 provides the user with a facility at step 1050 for performing any of various administrative tasks, e.g., selecting a language, changing a user name or password, adding a user name or password, and the like.

As is shown in FIG. 2B, the user begins the sub-process of starting a new estimate by entering personal and insurance information for a particular patient 30 at step 1055. The software application is designed to gather this entered information.

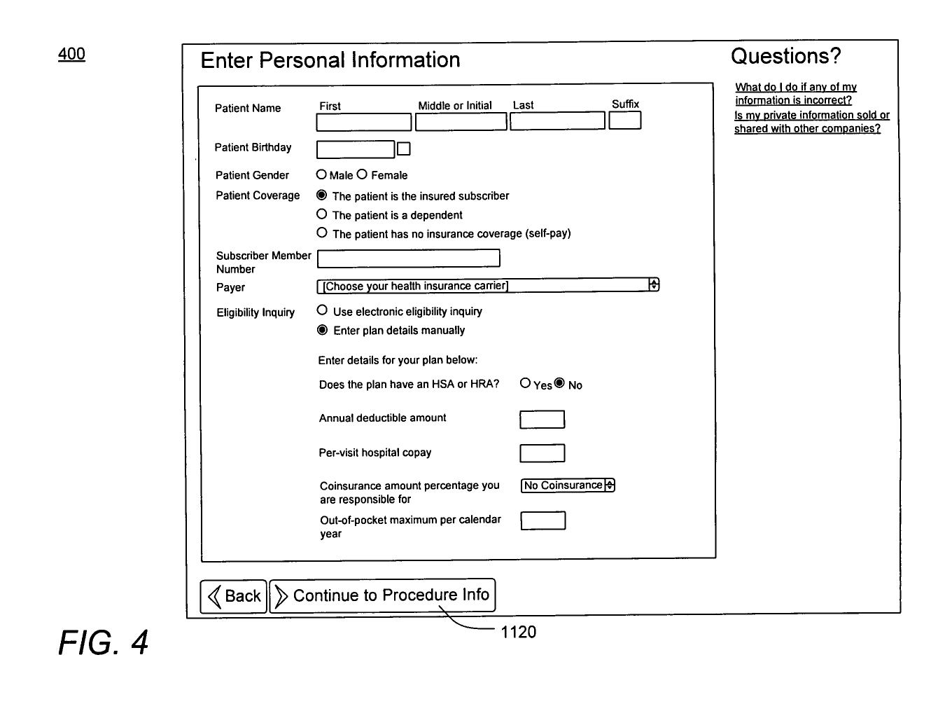

FIG. 4 is a screen view of an exemplary implementation of a patient information screen 400 of the user interface 42, presented to the user as part of the price estimate process 1000. The patient may be an insured subscriber, a dependent of the insured subscriber, or a non-insured person. Patient personal and insurance information is entered into the system 10 at the patient information screen 400. In the exemplary embodiment shown in FIG. 4, the personal information includes patient name, birth date, and gender. Preferably, the system core 12 provides basic field verification to ensure that data entered is valid. The user also inputs information about the patient's insurance status including the insurance subscriber identifier, the insurance carrier and dependent information, if applicable. It is contemplated that a patient's insurance carrier will be selectable from a drop down menu of available insurance carriers. However, if a patient's insurance carrier is not listed, it is possible to manually enter the patient's insurance carrier information. Once the personal and insurance information entry is complete at step 1060, then the eligibility engine 14 stores personal and insurance information for the patient at step 1065.

As shown in FIG. 4, the patient information screen 400 may also include information, either directly or via one or more links, to help the user through the process of entering personal and insurance information. For example, one link can be provided to address the problem of what a user should do if any of the patient's information is incorrect, while another link can be provided to address the issue of whether the patient's private information is sold or shared with other companies. It will be appreciated that other help or guidance information may be available on the screen 400 or by hotlink to another screen.

The eligibility engine 14 uses the information entered at the personal information screen to create an eligibility request that will be electronically sent to an electronic claim clearinghouse 18 for eligibility verification at step 1070. The eligibility engine 14 preferably communicates with the electronic claim clearinghouse 18 via a webservice API. A claim clearinghouse 18 is a company or entity that maintains connections to numerous insurance carriers, and therefore makes it easy for medical facilities to submit claims to any of the insurance carriers with which the clearinghouse 18 has connections. The electronic claim clearinghouse 18 provides a single point of contact for eligibility verification for the system 10. This way, the system 10 does not have to contact each insurance carrier individually. Currently, there are over a dozen electronic claim clearinghouses 18 to which the process may send an eligibility request. Because any one electronic claim clearinghouse 18 is unlikely to maintain connections to all insurance carriers, it may be necessary, in at least one contemplated commercial embodiment, to limit eligibility requests to those carriers affiliated a selected electronic claim clearinghouse. Alternatively, multiple electronic claim clearinghouses 18 may be supported. One commercial electronic claim clearinghouse suitable for use in at least one contemplated commercial embodiment is the MedData clearinghouse. In addition, although not illustrated, it will be appreciated that eligibility requests may be sent directly to one or more particular insurance carriers without going through a claim clearinghouse 18.

Pursuant to the Health Insurance Portability and Accountability Act (“HIPAA”), eligibility requests and responses must be formatted in a certain manner. HIPAA was passed in 1996 with the goal of reducing health care administrative prices. As a part of HIPAA, health insurance payers are required to use standard electronic formats established by the Secretary of Health and Human Services. Standard electronic formats have been established for health care benefit inquiries (requesting eligibility verification) and for the corresponding health care benefit responses (responding to a request for eligibility verification). In at least one embodiment, all requests (benefit inquiries) must be sent using an ANSI X12N 270 format (the “270 format”) and all responses must be sent using an ANSI X12N 271 format (the “271 format”). It will be appreciated, however, that other standardized or customized formats may likewise be utilized in some alternative embodiments.

The eligibility engine 14 takes the information entered at the patient information screen 400 and formats it into a benefit inquiry in the designated format (i.e., the 270 format), which is then sent to the clearinghouse 18 at step 1070. More particularly, the user-inputted personal information and insurance information is stored in an eligibility request table. The eligibility engine 14 then formats the required fields into XML and sends the benefit inquiry to the electronic claim clearinghouse 18 via “http: post” using a documented format set by the particular electronic claim clearinghouse 18. The electronic claim clearinghouse 18 responds with a benefit response in the designated format, usually corresponding to the format of the benefit inquiry (i.e., the 271 format), which indicates whether the patient 30 is covered by a particular insurance carrier, or not. This occurs at step 1075. If a patient 30 is covered by the insurance carrier, the response indicates the coverage amounts for which the patient 30 is eligible and also the deductible and copayment amounts for the patient 30. In one commercial embodiment, the response does not include information regarding whether a deductible has been met for a particular calendar year for the patient 30, although in at least one other embodiment of the present invention the response would include such information. The information provided by the electronic claim clearinghouse 18 is generally current as of the day of request only.

The benefit response information is parsed by the eligibility engine 14, which stores the eligibility information and insurance plan details into an eligibility inquiry response table at step 1105. The eligibility engine 14 then updates an estimate table with information that will be used later to determine a price estimate. The eligibility engine 14 essentially runs in the background of the process 1000 while the user moves on to the calculation sub-process beginning at step 1115, described below. Therefore, in at least one embodiment, the user interface 42 does not provide any visual indication to the user that the eligibility engine 14 is operating; however, the user will be notified of successful receipt of a benefit response at step 1110 or will be given a warning of failure. Typically, a benefit response will be received from the clearinghouse 18 within about approximately 30 seconds. If there is an issue with the eligibility engine 14, the user is interrupted and notified of the failure, at step 1090. Failures may include substantive errors (step 1080), such as: a determination that the patient 30 is no longer eligible for benefits, a determination that the patient 30 cannot be found (due either to an invalid member number or other incorrect personal details), or a determination that some eligibility information was received by the eligibility engine 14, but not enough to complete an estimate calculation (e.g. deductible information was received, but coinsurance information was not), or communication errors (step 1085), such as between the eligibility engine 14 and the electronic claim clearinghouse 18, or between the electronic claim clearinghouse 18 and a given payer.

If a failure occurs, the user may be given the option of manually entering insurance data at step 1100. Alternatively, the eligibility engine 14 may automatically resubmit the request or may provide the user with the option to resubmit the request. In some cases, the system 10 will not allow the user to proceed, such as in the event of a problem with eligibility, without first correcting the problem. For example, the user may be returned to the patient information screen 400 and given a suggested method for correcting the eligibility problem (e.g. instructing the user to double-check and re-enter a member number). In other cases, such as in the event of a communication failure, the system 10 may merely instruct the user to wait a few minutes and try resending. Clicking the “Continue to Procedure Info” button 405 will resubmit a new request to the clearinghouse if corrected information is provided. Notably, the patient information screen 400 also allows for bypassing of the electronic eligibility submission by selecting the “Enter plan details manually” option 410.

It will be appreciated that the various options, fields, and other elements of the user interface 42 that are presented via the patient information screen 400 and other screens of the user interface 42 may be rearranged, substituted, and the like with any other known graphical user interface element, or that such elements may instead be provided in the form of some other type of user interface, such as a voice-response system, without departing from the scope of the present invention.

In at least one embodiment, the benefit response data is stored, but is not available for export, such as to the medical facility itself. Optionally, however, the system 10 may be implemented such that the benefit response data is available for export to the facility, thereby simplifying the eligibility inquiry process for the facility itself.

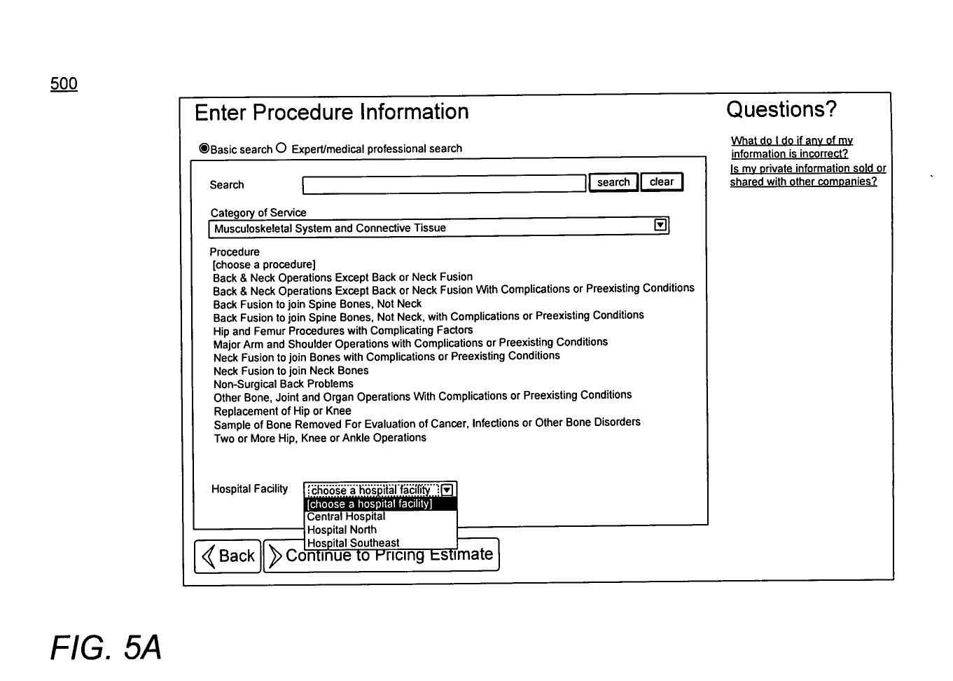

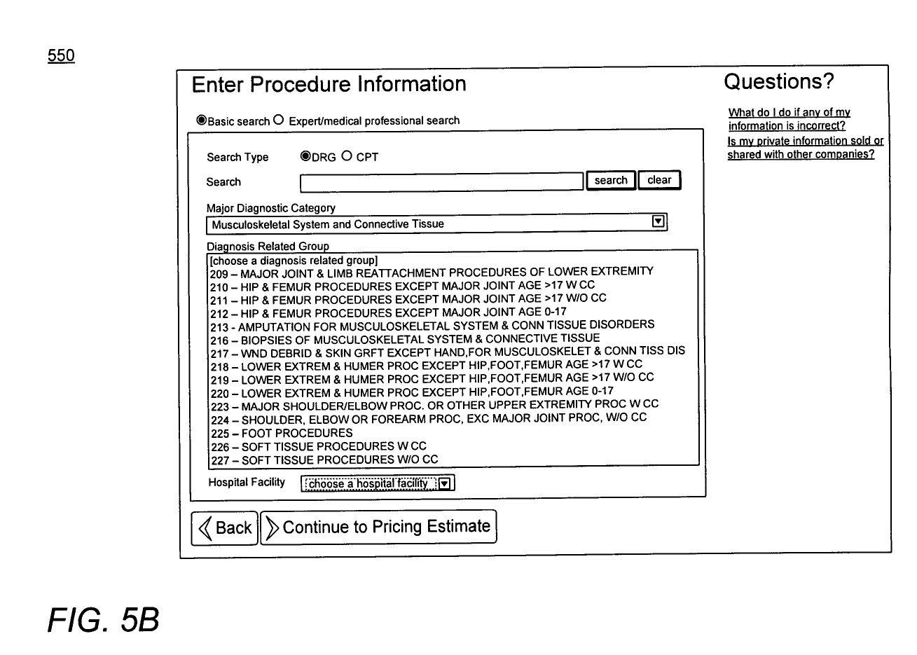

As shown in FIG. 2C, the user begins the calculation sub-process by performing a procedure search. As described previously, this may occur simultaneously with the operation of the eligibility engine 14, i.e., while the eligibility engine 14 operates in the background. FIGS. 5A and 5B are screen views of exemplary implementations of basic and expert procedure search screens 500,550 of the user interface 42, presented to the user as part of the price estimate process 1000. The calculation sub-process allows users to search a database of procedures using a basic search module or an expert/medical professional search module, with such choice being indicated at step 1115. The system 10 includes a database, which may be part of the system core 12, storing a list of medical procedures based on standard libraries of current procedural terminology (“CPT”) and diagnosis-related groups (“DRG”) codes and descriptions. CPT terminology is a 5-digit code used in medical billing and record systems that defines the medical procedures and medical services provided. DRG codes are a classification of hospital case types into groups expected to have similar hospital resource use. The groupings are conventionally based on diagnosis, procedure, age, gender, and the presence of complications or comorbidities. A comorbidity is an accompanying but unrelated pathological or disease process. Many illnesses present with common comorbidities that are unrelated but often present.

If at step 1115 the user selects the basic search, the user utilizes the basic procedure lookup facility to search the database procedure descriptions, as is indicated in step 1120 and illustrated in FIG. 5A. The user may search by querying keywords, which results in a list of procedures containing the entered keywords from which the user may select the desired procedure. In addition, with the basic search, a user may browse through categories of procedures organized by body part and select the desired procedure from the list. In order to avoid confusing the user, the CPT/DRG codes may be hidden from the user when a basic search is performed.

If at step 1115 the user wishes to use the expert search module, he uses the expert procedure lookup facility at step 1125. The expert procedure lookup facility, illustrated in FIG. 5B, prompts a user to select whether he wishes to use CPT or DRG to perform the search. Because, as described below, historical price data is conventionally stored by CPT or DRG code, the selection of such codes directly may help ensure that the price information delivered back is more likely to be the proper price information. Once a selection of terminology type is selected, the user may browse through categories of codes for which resulting procedures will be listed. The user may then select the desired procedure from the list. In order to provide comprehensive information, the CPT/DRG codes may be displayed to the user when an expert search is performed.

Preferably, the procedures that are included in the database (and that are made available to users) are limited according to the procedures actually available at the facility for which the inquiry is being made, according to the procedures that the facility wishes to have included, according to the procedures for which sufficient information exists to provide a reliable price estimate, or according to any other desirable criteria. This may be controlled by the process administrator.

Regardless of whether a user chooses the basic search method (step 1120) or the expert search method (step 1125), the user will be able to select a desired procedure from a provided list of procedures, at step 1130. If the desired procedure is not produced by the search method, a user may simply repeat the search using different search techniques. In at least one embodiment, the process 1000 allows for selection of a single procedure for a price estimate. However, it will be appreciated that the system 1000 could also be implemented to permit price estimates to be provided for multiple procedures at once. In addition, the user may select a particular hospital or other medical facility where the procedure will be performed. If the user is a customer service representative 40, and not the patient 30, then the facility choices may all pertain to a particular system or organization of affiliated hospitals or other facilities, with the facility choices typically being initially configured at implementation for the particular hospital system. In at least one contemplated commercial embodiment, the facility selection option will be a feature of the process for which a client will pay an additional fee. Therefore, the facility selection option will not be available for all clients. If the facility selection option is not available, average prices for all facilities can be used to calculate the price estimate.

Once a procedure is selected at step 1130, then at step 1135 the pricing engine 16 retrieves, via an interface, historical price data from a pricing database 20 populated by claims that have previously been paid by insurance carriers. The historical price data includes or is based on a catalog of claims that have paid by various insurance carriers but with patient-identifying data stripped off. Such payment information is publicly available but is in a form that is difficult to assimilate into useful data. The database of information is organized by insurance carrier/facility/DRG and by insurance carrier/facility/CPT. The database is created by analyzing paid claims and organizing them according to the categories listed above. Preferably, ANSI X12N 837 format (the “837 format”) claims and ANSI X12N 835 format (the “835 format”) payment remittances are analyzed in addition to ANSI X12N UB-92 format (the “UB-92 format”) claims. The 837 format is the HIPAA approved claim format for submission of a claim to an insurance carrier. The 835 format is the HIPAA approved remittance or payment format that the insurance carrier provides to a patient upon payment of a claim. The UB-92 format is the HIPAA approved claim format that hospitals and other institutional organizations may submit to insurance carriers. Additional formats may also be also be accommodated, but in at least one embodiment the ability to handle such additional formats may require the client to pay an additional fee.

As discussed above, the payment information provided by the HIPAA data formats is used to create a historical price database. In addition, care is taken to ensure that the historical price database is statistically valid. Statistical validity is an important feature of the price database because the information contained therein is utilized to create the price estimate for the patient.

Once the pricing data has been retrieved, pricing information is calculated for the selected procedure at step 1140. The pricing information may be calculated by a pricing module of the system 10; which pricing module may be found in the system core 12. The pricing module is a software application that utilizes the information previously entered into the system, i.e., insurance carrier, procedure, and facility, along with the retrieved pricing data, to calculate the pricing estimate for the patient 30.

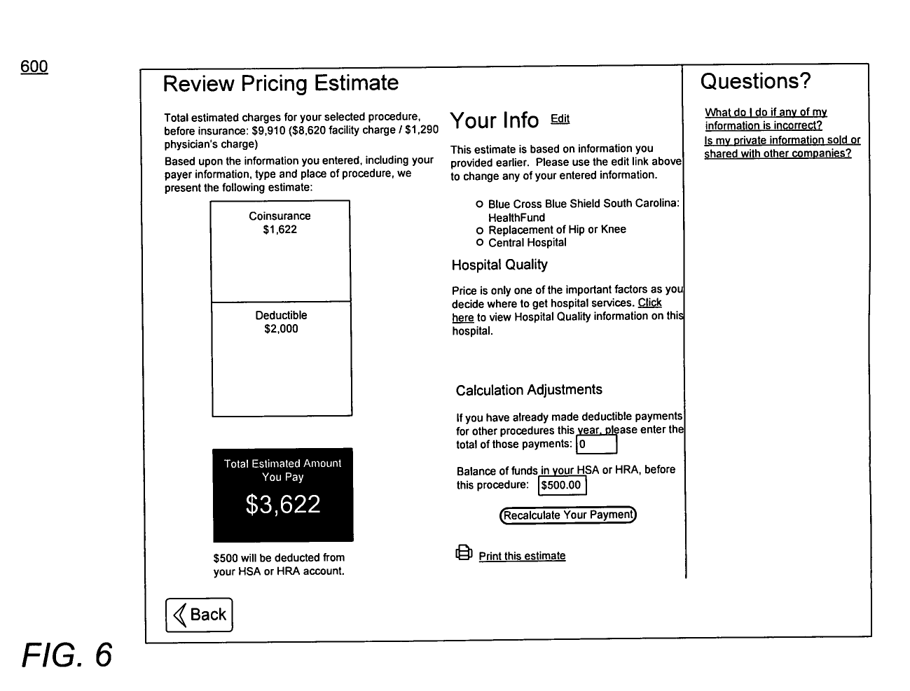

Pricing information is provided to the user at step 1145. Specifically, in a preferred embodiment, pricing information is provided to a user with a price estimate screen 600. FIG. 6 is a screen view of an exemplary implementation of a price estimate screen 600 of the user interface 42, presented to the user as part of the price estimate process 1000. The price estimate screen 600 preferably includes an estimate of the total charges for the procedure, an estimate of the amount a patient 30 will have to pay, and the information upon which the estimate is based, e.g., insurance carrier, procedure being performed, and facility where procedure is taking place. The total estimated charges for the procedure may or may not reflect a distinction between facility charges and physician fees; of course, this distinction cannot be provided if the source data reflects the distinction as well. The estimate of the amount the patient 30 will have to pay is preferably divided into an estimated copayment and the applicable deductible, so that the user can see where the prices are originating. In at least one embodiment, the monetary values are always displayed in whole dollars, with estimated charges, estimated insurance or prepayment savings and estimated total fees rounded to the nearest ten dollars. In addition to the pricing information, the price estimate screen 600 preferably also includes various information and disclaimers explaining the pricing information, the basis for its determination, and the like. A sampling of such information and disclaimers in illustrated in FIG. 6. In at least some embodiments, the price estimate screen 600 may also include a link to another screen, page or web site where facility quality information may be available.

It is contemplated that the price estimate calculation may subsequently be adjusted at step 1150 for certain types of information, if desired. For example, the price estimate calculation may be adjusted to account for deductible payments that have previously been made during the current calendar year. The price estimate screen 600 includes an input section for calculation adjustments including deductible payments already made in a particular year and balance of funds in a health savings account (“HSA”) or health reimbursement account (“HRA”) before the particular procedure. A health savings account is an account that a person can put money into to save for future medical expenses. A health reimbursement account is an insurance arrangement with an employer wherein an employer reimburses an employee for qualified medical expenses that are not covered by a group health insurance plan. It is contemplated that other information that will affect the price estimate may be entered into the calculation adjustment input section, or considered in the calculation adjustment, to alter the estimated price estimate. Once information is entered into the calculation adjustment section of the screen 600, payment can then be recalculated based on the provided information. If the user does not wish to adjust the price estimate calculation, the price estimate may be printed for a patient at step 1155. Further, the price estimate may be stored at step 1160 for future retrieval and review, described previously, and the eligibility request and response can be logged. Once the price estimate has been generated and stored, the price estimate process 1000 for the particular procedure ends. The user may begin the process 1000 again for another procedure or for another patient 30. Of course, it will be appreciated that, although not illustrated, operation of the user interface 42 itself may return to the state indicated at step 1015, or to any other desired location in the process 1000.

In summary, the price estimate process 1000 is used as follows. A user logs into the authorization screen 300 using predetermined login information, e.g., group number, username, and password. Once a user is logged in, a personal information screen 400 appears. Patient personal information and insurance carrier information is entered by selecting choices from various pull down menus or by manually entering the information. The eligibility engine 14 works in the background to communicate with the clearinghouse 18 while the user is presented with the procedure screen 500,550. The user may search using basic or expert search techniques for the applicable procedure. If the particular process implementation includes a facility selection function, the user may select the particular facility from a pulldown menu. The process 1000 then utilizes the pricing engine 16 to calculate a price estimate for the patient 30 based on the information that was provided by the user. The price estimate screen 600 displays the price estimate that the patient 30 will have to pay for a particular procedure at a particular facility (if the process includes this feature). The price estimate may be divided into coinsurance and deductible to better inform the user and patient 30 of the price breakdown.

A user may save a particular price estimate and use the process 1000 to calculate a new price estimate based on different parameters. In addition, the user may use the calculation adjustment portion of the price estimate screen 600 to understand how certain factors, e.g., deductible already reached for the year or money left in HSA or HRA account, affect the existing price estimate.

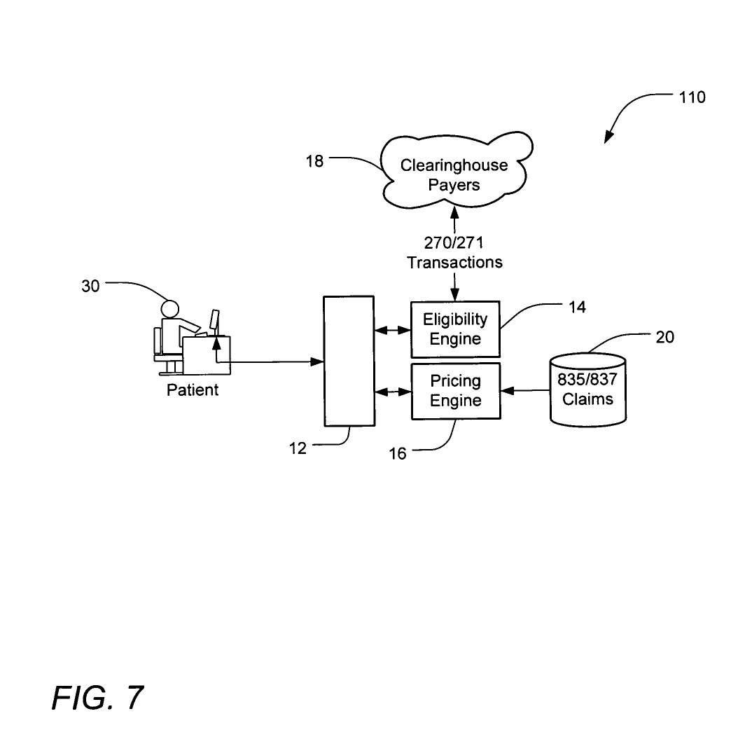

FIG. 7 is a schematic representation of a price estimate system 110 in accordance with another preferred embodiment of the present invention. While it has been shown and described herein that the patient 30 communicates with a customer service representative 40 who accesses the system 10, it is contemplated that in alternative embodiments of the invention, the patient 30 may be able to access the system 110 directly. In this arrangement, a user interface is provided that is similar to the one described above but including any changes necessary to permit an untrained user to interface directly with the rest of the system 110. Such changes will be appreciated by the Ordinary Artisan.

The system 10 and price estimate process 1000 of the present invention thus provide robust means for assimilating a vast and diverse amount of information to provide patients 30 with a price estimate for a procedure or procedures that they are planning to have. The price estimate process 1000 allows patients 30 to feel more in control of their medical care. Rather than being completely uninformed of the expected prices of medical procedures, patients 30 are able to learn what their expected medical costs are likely to be and plan accordingly. The price estimate process 1000 is equally beneficial to facilities. It enables the facilities to provide their patients 30 with estimates of medical procedure prices. Such information has not been readily available in the past because of the mass of information that has to be assimilated in order to provide such estimates.

In at least one commercial embodiment of each of the foregoing embodiments, one or more described features of the process may require an additional fee. Therefore, these features may not be available for all patients 30, users, or clients.

Based on the foregoing information, it is readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to its preferred embodiment, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof. Although specific terms are employed herein, they are used in a generic and descriptive sense only and not for the purpose of limitation.

1. A system for providing price information for medical procedures, comprising:
(a) a user interface configured to receive patient information corresponding to a patient;
(b) an eligibility engine configured to send a health care benefit inquiry and receive a health care benefit response from an insurer or a clearinghouse for a plurality of insurers based on received patient information; and
(c) a pricing engine configured to request and receive price data for a particular medical procedure based on the received patient information;
(d) wherein the user interface is further configured to present pricing information to a user based on the received health care benefit response and the received price data.

2. The system of claim 1, wherein:
(a) the eligibility engine, by sending the health care benefit inquiry and receiving the health care benefit response, determines whether and to what extent the patient is eligible for insurance benefits; and
(b) the pricing engine communicates with an historical pricing database to receive the price data for the particular medical procedure.

3. The system of claim 2, wherein the patient information comprises information pertaining to the particular medical procedure.

4. The system of claim 2, wherein the patient information comprises insurance information for the patient.

5 . The system of claim 2, wherein the user interface comprises an authorization module configured to determine security clearance of a user thereof.

6. The system of claim 2, wherein the user interface is accessible by the user via a network.

7. The system of claim 2, wherein the eligibility engine sends health care benefit inquiries using an ANSI X12N 270 electronic format.

8. The system of claim 2, wherein the eligibility engine receives health care benefit responses using an ANSI X12N 271 electronic format.

9. The system of claim 2, wherein the health care benefit response comprises coverage amounts for which the patient is eligible.

10. The system of claim 9, wherein the health care benefit response further comprises a deductible amount for the patient.

11. The system of claim 9, wherein the health care benefit response further comprises a copayment amount for the patient.

12. The system of claim 2, wherein the user interface is further configured to receive information pertaining to a particular hospital or medical facility.

13. The system of claim 2, wherein the pricing information comprises an estimate of a total cost of the particular medical procedure.

14. The system of claim 2, wherein the pricing information comprises an estimate of an amount that the patient is required to pay in connection with the particular medical procedure.

15. A system for providing price information for medical procedures, comprising:
(a) a user interface accessible to a user via a network and configured to receive patient information corresponding to a patient;
(b) an eligibility engine configured to send a health care benefit inquiry and receive a health care benefit response from an insurer or a clearinghouse for a plurality of insurers based on received patient information to determine whether and to what extent the patient is eligible for insurance benefits; and
(c) a pricing engine configured to communicate with an historical pricing database to request and receive price data for a particular medical procedure based on the received patient information;
(d) wherein the user interface is further configured to present pricing information to the user based on the received health care benefit response and the received price data; and
(e) wherein the pricing information comprises an estimate of an amount that the patient is required to pay in connection with the particular medical procedure.

16. The system of claim 15, wherein the eligibility engine sends health care benefit inquiries using an ANSI X12N 270 electronic format.

17. The system of claim 15, wherein the eligibility engine receives health care benefit responses using an ANSI X12N 271 electronic format.

18. The system of claim 15, wherein the user interface is configured to receive information pertaining to a particular hospital or medical facility.

19. A method of providing price information for medical procedures, comprising:
(a) selecting a medical procedure whose price is to be estimated;
(b) sending a health care benefit inquiry via a first interface;
(c) receiving a health care benefit response via the first interface;
(d) requesting price data, from a database, for the selected medical procedure via a second interface; and
(e) receiving price data, from the database, for the requested medical procedure via the second interface.

20. The method of claim 19, further comprising calculating an estimated price for the medical procedure based on the received health care benefit response and the received price data.
